(19) United States
(12) Patent Application Publication
(10) Pub. No.: US 2019/0057332 A1
(43) Pub. Date: Feb. 21, 2019

(54) MODELING ASSOCIATIONS BETWEEN MULTIPLE PRODUCTS

(71) Applicant: Hybris AG, Zug (CH)

(72) Inventor: Ahmad Hassan, Belfast (GB)

(21) Appl. No.: 15/677,586

(22) Filed: Aug. 15, 2017

(51) Int. Cl. G06Q 10/06; G06F 17/18; G06F 17/11

(52) U.S. Cl. CPC G06Q 10/067; G06F 17/11; G06F 17/18

(57) ABSTRACT

Methods, systems, and computer-readable storage media for providing computer-executable association rules between a plurality of physical objects, implementations including receiving historical data associated with each physical object in the plurality of physical objects over a defined time period, for each physical object, processing at least a portion of the historical data to determine one or more of a mean, a median, and a mode, determining an association between at least two physical objects of the plurality of physical objects based one or more of the mean, the median, and the mode of the respective at least two physical objects, providing at least one computer-executable association rule based on the association, and transmitting the at least one computer-executable association rule to a system, the system processing the at least one computer-executable association rule to perform at least one function of the system.

### BACKGROUND

Enterprises seek continuous improvement of supply chain processes. Efficiencies gained at each step of the supply chain can have a significant impact on the performance of the enterprise. One challenge includes predicting product demand. This can be achieved through modeling product associations (e.g., how the sale of one product impacts the sale of another product). For example, data mining techniques have been used to extract association rules from massive data sets, the association rules collectively modeling product associations. For example, historical data can indicate that as sales of a first product increase, sales of a second product increase (or decrease). Consequently, a positive (or negative) association can exist between the two products. Such data mining techniques, however, can be time and computing-resource intensive, as massive amounts of data need to be processed to provide robust product association rules. Further, such product association rules can be relatively complex, which can burden computing resources when implementing the rules.

### SUMMARY

Implementations of the present disclosure are generally directed to modeling product associations. More particularly, implementations of the present disclosure are directed to extending an inverse Weibull distribution to provide product associations between multiple products. In some implementations, actions include receiving historical data associated with each physical object in the plurality of physical objects over a defined time period, for each physical object, processing at least a portion of the historical data to determine one or more of a mean, a median, and a mode, determining an association between at least two physical objects of the plurality of physical objects based one or more of the mean, the median, and the mode of the respective at least two physical objects, providing at least one computer-executable association rule based on the association, and transmitting the at least one computer-executable association rule to a system, the system processing the at least one computer-executable association rule to perform at least one function of the system. Other implementations of this aspect include corresponding systems, apparatus, and computer programs, configured to perform the actions of the methods, encoded on computer storage devices.

These and other implementations can each optionally include one or more of the following features: the at least one computer-executable association rule includes identifiers of the respective at least two physical objects; the time period includes a quarter of a year; the system includes an enterprise resource planning (ERP) system; the at least one function includes determining a second quantity of a first physical object of the at least two physical objects based on a third quantity of a second physical object of the at least two physical objects; a first parameter of each of the mean, median, and mode is determined based on a second parameter; and the second parameters is selected from a plurality of previously determined values.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example module architecture in accordance with implementations of the present disclosure.

FIG. 3 an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to modeling product associations. More particularly, implementations of the present disclosure are directed to extending an inverse Weibull distribution to provide product associations between multiple products. Implementations can include actions of receiving historical data associated with each physical object in the plurality of physical objects over a defined time period, for each physical object, processing at least a portion of the historical data to determine one or more of a mean, a median, and a mode, determining an association between at least two physical objects of the plurality of physical objects based one or more of the mean, the median, and the mode of the respective at least two physical objects, providing at least one computer-executable association rule based on the association, and transmitting the at least one computer-executable association rule to a system, the system processing the at least one computer-executable association rule to perform at least one function of the system.

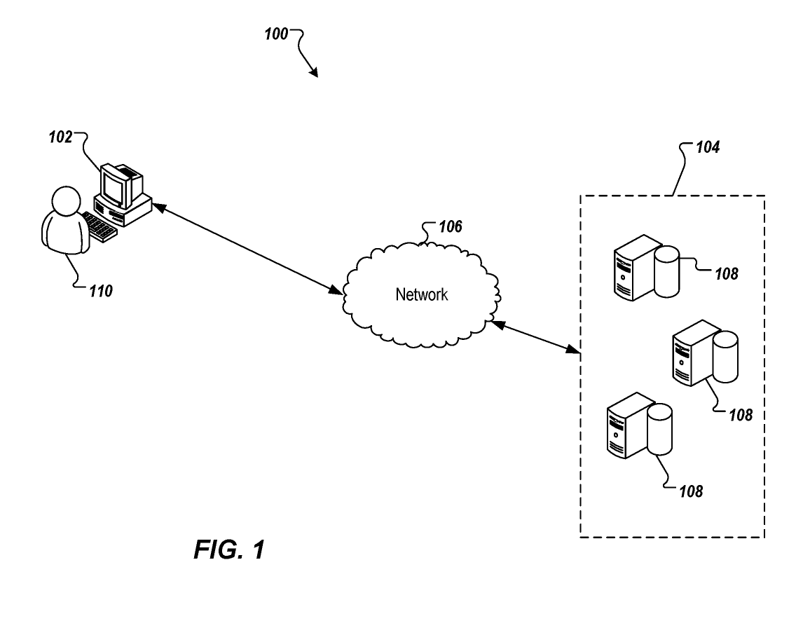

FIG. 1 depicts an example architecture 100 that can be used to execute implementations of the present disclosure. In the depicted example, the example architecture 100 includes one or more client devices 102, a server system 104 and a network 106. The server system 104 includes one or more server devices 108. In the depicted example, a user 110 interacts with the client device 102. In an example context, the user 110 can include a user, who interacts with an application that is hosted by the server system 104.

In some examples, the client device 102 can communicate with one or more of the server devices 108 over the network 106. In some examples, the client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 108 includes at least one server and at least one data store. In the example of FIG. 1, the server devices 108 are intended to represent various forms of servers including, but not limited to a web server, an application server, a proxy server, a network server, and/or a server pool. In general, server systems accept requests for application services and provides such services to any number of client devices (e.g., the client device 102) over the network 106.

In accordance with implementations of the present disclosure, the server system 104 can host a product association service (e.g., provided as one or more computer-executable programs executed by one or more computing devices). For example, input data can be provided to the server system, and the server system can process the input data through the product association service to provide one or more product association models. The product association model(s) can be used to process incoming data (e.g., e-commerce user activity) to provide one or more metrics indicating associations between multiple products.

As introduced above, implementations of the present disclosure provide a statistical technique for modeling product associations. More particularly, implementations of the present disclosure introduce an extension of an inverse Weibull distribution to provide a product association model. In some implementations, a probability density function (PDF) of the product association can be modeled based on an inverse Weibull distribution provided as:

$$f ( x ) = \frac{β}{{γ ( x - a )}^{β + 1}} {e}^{- \frac{1}{{γ ( x - a )}^{β + 1}}} \qquad ( 1 )$$

where x is predicted demand for a product (x≥0), α is a minimum value of x provided from historical data, γ is a scale parameter (γ>0), β is a shape parameter (β>0). Based on Equation 1, a cumulative distribution function (CDF) can be provided as:

$$F ( x ) = {e}^{- \frac{1}{{γ ( x - a )}^{β + 1}}} \qquad ( 2 )$$

In accordance with implementations of the present disclosure, a quantile function can be provided to estimate quarterly sales of a product. In general, the quantile function (or inverse CDF) provides, for a given probability in the probability distribution of a random variable, the value at which the probability of the random variable is less than or equal to the given probability. In some examples, the quantile function can be based on the CDF of Equation 2, and can be provided as:

$$F ( {q}_{α} ) = {e}^{- \frac{1}{{γ ( q α - a )}^{β + 1}}} = α \qquad ( 3 )$$

where α is the percentile of the probability distribution, and q_{α} is the product sales for a product in a given time period (e.g., quarterly product sales). From Equation 3, the following example relationship can be provided:

$$( {q}_{α} - a ) = {( \frac{1}{γ ln α} )}^{\frac{1}{β}} \qquad ( 4 )$$

In accordance with implementations of the present disclosure, the following new PDF can be provided for a product based on observed sales values (historical sales data):

$$f ( w ) = \frac{β}{{γ ( w - a )}^{β + 1}} {e}^{- \frac{1}{{γ ( w - a )}^{β}}} \qquad ( 5 )$$

where w is the predicted value (e.g., for a current or future quarter), and a is the observed value (e.g., for a past quarter). In some implementations, Equation 5 can be minimized to provide:

$$γ = \frac{β}{β + 1} ( w - a ) \qquad ( 6 )$$

In some implementations, Equation 4 and Equation 6 can be combined to provide:

$$( {q}_{α} - a ) {( w - a )}^{\frac{1}{β}} = {( \frac{β + 1}{β ln α} )}^{\frac{1}{β}} \qquad ( 7 )$$

In accordance with implementations of the present disclosure, the model of Equation 7 can be used to provide the mean (average value), median (middle value), and mode (most repeated value) as the following example relationships, respectively:

$$\begin{matrix}Mean = a + \frac{\sqrt{1 - \frac{1}{β}}}{{γ}^{\frac{1}{β}}} & ( 8 ) \\ Median = a + {( ln ( {2}^{- γ} ) )}^{\frac{1}{β}} & ( 9 ) \\ Mode = a + \frac{{( 1 + \frac{1}{β} )}^{- \frac{1}{β}}}{{γ}^{\frac{1}{β}}} & ( 10 )\end{matrix}$$

In accordance with implementations of the present disclosure, mean, median, and mode can be determined for multiple products based on historical data, and multiple products can be associated with one another based on the mean, median, and/or mode values. For example, for a given quarter, the mean, median, and mode of each product in a set of products can be determined. As a non-limiting example, a product A, and a product B can be considered for the fourth quarter (Q4) of a year (e.g., the year including quarters Q1, Q2, Q3, Q4). It can be desired to determine a product association, if any, between the product A and the product B based on historical data for the products. In some examples, the historical data includes respective sales in previous quarters (e.g., historical data from Q4-2016, Q4-2015, Q4-2014).

In accordance with implementations of the present disclosure, Equations 8, 9, and 10 can be used to determine the mean, median, and mode, respectively, for each of the product A, and the product B over the historical time periods. In some examples, γ is determined based on Equation 6, and β is selected. In some examples, multiple values for β can be provided based on observations from distributions of the historical data, and a desired value of β can be selected from one of the multiple, observed values. The example resulting values can be provided:

| | Q4-2014 | | | Q4-2015 | | | Q4-2016 | | |
|---|---|---|---|---|---|---|---|---|---|
| | Mean | Median | Mode | Mean | Median | Mode | Mean | Median | Mode |
| ProdA | V_{A, 1, 14} | V_{A, 2, 14} | V_{A, 3, 14} | V_{A, 1, 15} | V_{A, 2, 15} | V_{A, 3, 15} | V_{A, 1, 16} | V_{A, 2, 16} | V_{A, 3, 16} |
| ProdB | V_{B, 1, 14} | V_{B, 2, 14} | V_{B, 3, 14} | V_{B, 1, 15} | V_{B, 2, 15} | V_{B, 3, 15} | V_{B, 1, 16} | V_{B, 2, 16} | V_{B, 3, 16} |

In some implementations, an association can be determined between the product A and the product B based on session data. In some examples, the product data is provided from user sessions with platforms (e.g., e-commerce platforms used to purchase products). For example, during a user session, a user may purchase two or more products. In some examples, the session data indicates co-bought products during user sessions, popular products within sessions, and frequently bought products across sessions. Accordingly, a tentative association can be provided based on the number of times a product A is bought, and the number of times the product A is bought with product B.

In accordance with implementations of the present disclosure, a formal association can be provided based on one or more of the mean, median, and mode. More particularly, the total number of product sales is one indicator of association between products, while the statistical information of the present disclosure provides additional indicators of association. In this manner, the statistical metrics improve the reliability of the resulting product associations.

In some examples, there may be no association, there may be a positive association (e.g., what happens to the product A also happens to the product B), or there may be a negative association (e.g., what happens to the product A, the opposite happens to the product B). For example, it can be determined that the mean value of the product A increases in Q4 (e.g., over Q3), but the mean value of the product B makes no change in Q4 (e.g., over Q3), or vice-versa. Consequently, it can be determined that there is no association as between the product A, and the product B.

As another example, it can be determined that the mean value of the product A increases (or decreases) in Q4 (e.g., over Q3), and that the mean value of the product B also increases (or decreases) in Q4 (e.g., over Q3). Consequently, it can be determined that there is a positive association between the product A, and the product B (e.g., the product A and the product B are proportional to one another). As another example, it can be determined that the mean value of the product A increases (or decreases) in Q4 (e.g., over Q3), and that the mean value of the product B decreases (or increases) in Q4 (e.g., over Q3). Consequently, it can be determined that there is a negative association between the product A, and the product B (e.g., the product A and the product B are inversely proportional to one another). In some examples, a degree, to which the product A and the product B are (inversely) proportional to one another can be determined. For example, for each product A that is sold, X times of product B is sold (e.g., X≠0).

In accordance with implementations of the present disclosure, the associations can be translated into computer-readable association rules, which can be included in one or more applications. For example, an enterprise resource planning (ERP) system can receive the association rules, and can execute the association rule to perform resource planning functionality. In some examples, the ERP system can determine a number of the product A that is to be ordered for a future quarter (e.g., Q4-2018). The ERP system can leverage an association rule between the product A, and the product B to determine a number of the product B that is to be order for the future quarter. In some examples, an association rule can be provided as a rule tree that includes a parent node representing a particular product (e.g., product A), and one or more child nodes representing other products (e.g., product B). In some examples, edges are provided between nodes, each edge representing a type of association between nodes.

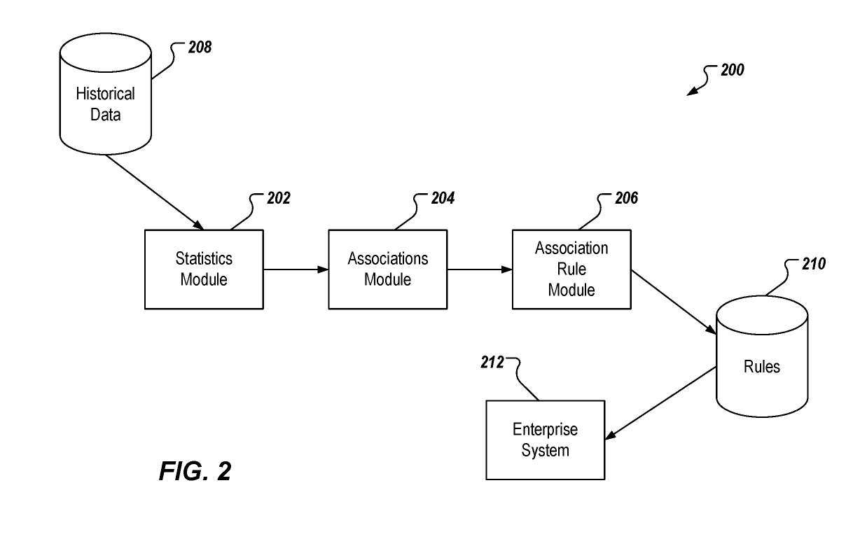

FIG. 2 depicts an example module architecture 200 in accordance with implementations of the present disclosure. A statistics module 202, an associations module 204, and an association rule module 206. In some examples, each module can be provided as one or more computer-executable programs that are executed by one or more computing devices. In the example of FIG. 2, a historical data database 208, a rules database 210, and an enterprise system 212 are depicted. In accordance with implementations of the present disclosure, and as described in detail herein, the historical data database 208 stores historical data regarding quantities of respective physical objects (e.g., products). In some examples, the quantities are provided for respective time periods (e.g., daily, weekly, monthly, quarterly, yearly).

In accordance with implementations of the present disclosure, the statistics module 202 provides one or more statistics for a plurality of physical objects based on the historical data associated with respective physical objects. In some examples, the statistics module 202 receives the historical data from the historical data database 202. In some examples, the statistics module 202 provides the statistics in response to a request from the enterprise system 212. In some examples, the statistics module 202 receives input (e.g., from the enterprise system 212). Example input can include a request to determine the statistics, identifiers respectively identifying two or more products, for which statistics are to be determined, and one or more parameters. Example parameter can include a value for the shape parameter β, and a time period for the historical data.

In some examples, the statistics module 202 determines one or more of the mean, the median, and the mode for each physical object that is being considered based on Equations 8, 9, and 10, described herein. In some implementations, the associations module 204 receives the statistics for each physical object, and determines whether there is any association between at least two physical objects. If there is an association between at least two physical objects, the associations module 204 can determine whether it is a negative association (e.g., inversely proportional), or a positive association (e.g., proportional), and a degree, to which the products are associated (e.g., a ratio of quantities of the physical objects).

In some implementations, if there is an association, association data is provided to the association rule module 206 from the associations module 204. Example association rule data can include identifiers identifying at least two physical objects, a type of association, and a degree of association. In some examples, the association rule module 206 provides one or more computer-executable association rules based on the association data. In some examples, the association rule module 206 accesses provides an association rule using a template association rule. An example template association rule can include computer-executable code having one or more placeholders for parameters (e.g., identifiers, degree). For example, the association rule module 206 can retrieve a template association rule based on a type of the association, and can input parameters to the template association rule to provide the computer-executable association rule. The one or more association rules are stored in the rules database 210.

In some implementations, the enterprise system 212 queries the rules database 210 for any association rules that may be applicable to a set of physical objects (e.g., two or more physical objects). For example, the enterprise system 212 can transmit a query to the rules database 210, which query includes identifiers assigned to each physical object in the set of physical objects. The rules database 210 can process the query to identify an association rule(s) assigned to two or more physical objects in the set of physical objects. In some examples, if no association rule is stored in the rules database 210 that is assigned to two or more physical objects in the set of physical objects, an empty query result is returned. In some examples, if at least one association rule is stored in the rules database 210 that is assigned to two or more physical objects in the set of physical objects, query result is returned that includes the at least one association rule. In some examples, the enterprise system 212 processes the at least one association rule to perform one or more functions.

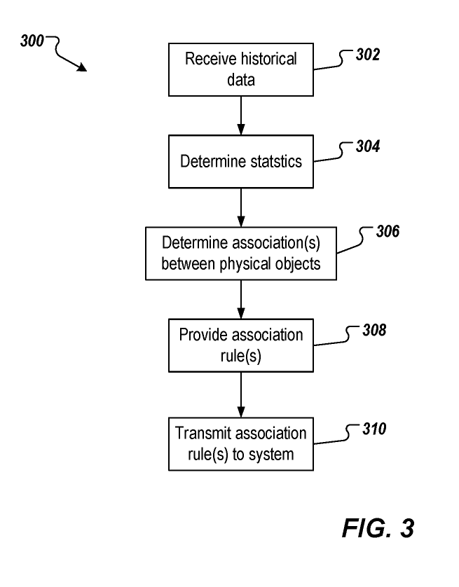

FIG. 3 depicts an example process 300 that can be executed in accordance with implementations of the present disclosure. In some examples, the example process 300 can be provided by one or more computer-executable programs executed using one or more computing devices. The example process 300 can be performed to provide associations between products in accordance with implementations of the present disclosure.

Historical data is received (302). For example, the statistics module 202 of FIG. 2 receives historical data from the historical data database 208. In some examples, the historical data includes session data indicating physical objects associated with one another through one or more user sessions (e.g., products purchased together during a user session with an e-commerce system). In some examples, the historical data includes quantities of respective physical objects (e.g., products). In some examples, the quantities are provided for respective time periods (e.g., daily, weekly, monthly, quarterly, yearly).

Statistical metrics are determined (304). For example, the statistics module 202 provides one or more statistical metrics based on at least a portion of the historical data. In some examples, the statistical metrics include mean, median, and/or mode, determined using Equations 8, 9, and 10, respectively, of the present disclosure. One or more associations between physical objects are determined (306). For example, the associations module 204 determines associations between physical objects (e.g., products). In some examples, the associations module 204 receives the statistical metrics, and at least a portion of the historical data (e.g., data indicating co-purchased products during user sessions), and processes both to determine the one or more associations.

Association rules are provided (308). For example, the association rule module 206 processes the one or more associations to provide respective, computer-executable association rules, as described herein. In some examples, the association rules are stored in computer-readable memory, such as the rules database 210. Association rules are transmitted to a system (310). For example, one or more association rules are provided to a computer-implemented system (e.g., ERP system) that may process the rules to perform one or more functions (e.g., plan resources, order products).

Implementations of the present disclosure provide one or more of the following example advantages. In some examples, implementations of the present disclosure reduce the amount of computing resources that would otherwise be required to determine robust product associations. Consequently, efficiencies in determining product associations in accordance with the present disclosure enable real-time decision-making. For example, an e-commerce platform using product associations of the present disclosure can enable up-selling, where a newer and better of version of similar products can be introduced to user at a point-of-purchase in the e-commerce platform. As another example, cross-selling can be provided where, if one product is getting more sales, then similar associated products can be advertised along with that product to promote sales of associated products. Another example includes encouraging users to purchase accessories when a certain products are purchased.

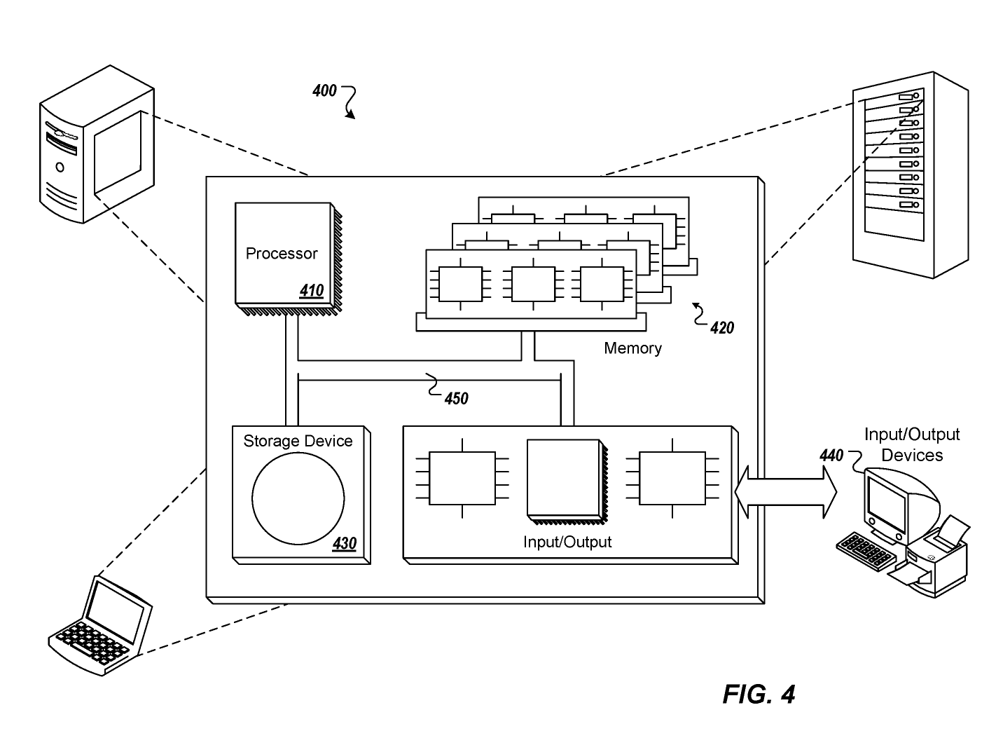

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for providing computer-executable association rules between a plurality of physical objects, the method being executed by one or more processors and comprising:
receiving, by the one or more processors, historical data associated with each physical object in the plurality of physical objects over a defined time period;
for each physical object, processing, by the one or more processors, at least a portion of the historical data to determine one or more of a mean, a median, and a mode, respectively as:
$$\begin{matrix}Mean = a + \frac{\sqrt{1 - \frac{1}{β}}}{{γ}^{\frac{1}{β}}} \\ Median = a + {( ln ( {2}^{- γ} ) )}^{\frac{1}{β}} \\ Mode = a + \frac{{( 1 + \frac{1}{β} )}^{- \frac{1}{β}}}{{γ}^{\frac{1}{β}}}\end{matrix}$$
where α is a first quantity of a respective physical object within the time period, γ is scale parameter, and β is a shape parameter;
determining, by the one or more processors, an association between at least two physical objects of the plurality of physical objects based one or more of the mean, the median, and the mode of the respective at least two physical objects;
providing, by the one or more processors, at least one computer-executable association rule based on the association; and
transmitting, by the one or more processors, the at least one computer-executable association rule to a system, the system processing the at least one computer-executable association rule to perform at least one function of the system.

2. The method of claim 1, wherein the at least one computer-executable association rule comprises identifiers of the respective at least two physical objects.

3. The method of claim 1, wherein the time period comprises a quarter of a year.

4. The method of claim 1, wherein the system comprises an enterprise resource planning (ERP) system.

5. The method of claim 4, wherein the at least one function comprises determining a second quantity of a first physical object of the at least two physical objects based on a third quantity of a second physical object of the at least two physical objects.

6. The method of claim 1, wherein γ is determined as:
$$γ = \frac{β}{β + 1} ( w - a )$$
where w is a second quantity of the respective physical object.

7. The method of claim 1, wherein β is selected from a plurality of previously determined values.

8. A non-transitory computer-readable storage medium coupled to one or more processors and having instructions stored thereon which, when executed by the one or more processors, cause the one or more processors to perform operations for providing computer-executable association rules between a plurality of physical objects, the operations comprising:
receiving historical data associated with each physical object in the plurality of physical objects over a defined time period;
for each physical object, processing at least a portion of the historical data to determine one or more of a mean, a median, and a mode, respectively as:
$$\begin{matrix}Mean = a + \frac{\sqrt{1 - \frac{1}{β}}}{{γ}^{\frac{1}{β}}} \\ Median = a + {( ln ( {2}^{- γ} ) )}^{\frac{1}{β}} \\ Mode = a + \frac{{( 1 + \frac{1}{β} )}^{- \frac{1}{β}}}{{γ}^{\frac{1}{β}}}\end{matrix}$$
where α is a first quantity of a respective physical object within the time period, γ is scale parameter, and β is a shape parameter;
determining an association between at least two physical objects of the plurality of physical objects based one or more of the mean, the median, and the mode of the respective at least two physical objects;
providing at least one computer-executable association rule based on the association; and
transmitting the at least one computer-executable association rule to a system, the system processing the at least one computer-executable association rule to perform at least one function of the system.

9. The computer-readable storage medium of claim 8, wherein the at least one computer-executable association rule comprises identifiers of the respective at least two physical objects.

10. The computer-readable storage medium of claim 8, wherein the time period comprises a quarter of a year.

11. The computer-readable storage medium of claim 8, wherein the system comprises an enterprise resource planning (ERP) system.

12. The computer-readable storage medium of claim 11, wherein the at least one function comprises determining a second quantity of a first physical object of the at least two physical objects based on a third quantity of a second physical object of the at least two physical objects.

13. The computer-readable storage medium of claim 8, wherein γ is determined as:
$$γ = \frac{β}{β + 1} ( w - a )$$
where w is a second quantity of the respective physical object.

14. The computer-readable storage medium of claim 8, wherein β is selected from a plurality of previously determined values.

15. A system, comprising:
a computing device; and
a computer-readable storage device coupled to the computing device and having instructions stored thereon which, when executed by the computing device, cause the computing device to perform operations for providing computer-executable association rules between a plurality of physical objects, the operations comprising:
receiving historical data associated with each physical object in the plurality of physical objects over a defined time period;
for each physical object, processing at least a portion of the historical data to determine one or more of a mean, a median, and a mode, respectively as:
$$\begin{matrix}Mean = a + \frac{\sqrt{1 - \frac{1}{β}}}{{γ}^{\frac{1}{β}}} \\ Median = a + {( ln ( {2}^{- γ} ) )}^{\frac{1}{β}} \\ Mode = a + \frac{{( 1 + \frac{1}{β} )}^{- \frac{1}{β}}}{{γ}^{\frac{1}{β}}}\end{matrix}$$
where α is a first quantity of a respective physical object within the time period, γ is scale parameter, and β is a shape parameter;
determining an association between at least two physical objects of the plurality of physical objects based one or more of the mean, the median, and the mode of the respective at least two physical objects;
providing at least one computer-executable association rule based on the association; and
transmitting the at least one computer-executable association rule to a system, the system processing the at least one computer-executable association rule to perform at least one function of the system.

16. The system of claim 15, wherein the at least one computer-executable association rule comprises identifiers of the respective at least two physical objects.

17. The system of claim 15, wherein the time period comprises a quarter of a year.

18. The system of claim 15, wherein the system comprises an enterprise resource planning (ERP) system.

19. The system of claim 18, wherein the at least one function comprises determining a second quantity of a first physical object of the at least two physical objects based on a third quantity of a second physical object of the at least two physical objects.

20. The system of claim 15, wherein γ is determined as:
$$γ = \frac{β}{β + 1} ( w - a )$$
where w is a second quantity of the respective physical object.
